(19) United States
(12) Patent Application Publication
(10) Pub. No.: US 2007/0265941 A1
(43) Pub. Date: Nov. 15, 2007

(54) Parametric search

(76) Inventors: Richard D. Fletcher, Austin, TX (US); James S. Clay, Austin, TX (US); Lawrence J. Steifer, Ham Lake, MN (US)

Correspondence Address: 3M INNOVATIVE PROPERTIES COMPANY, PO BOX 33427, ST. PAUL, MN, 55133-3427, US

(21) Appl. No.: 11/408,372

(22) Filed: Apr. 21, 2006

(51) Int. Cl. G06Q 30/00

(52) U.S. Cl. 705/27

(57) ABSTRACT

Various techniques for a method for performing a parametric search on a database. In one implementation, the method includes displaying one or more first graphical elements through a graphical user interface. Each first graphical element represents an application of one or more products. The method may further include displaying one or more second graphical elements in response to selection of a first graphical element. Each second graphical element represents a product family that may be used in an application that corresponds to selection of the first graphical element. The method may further include displaying one or more third and/or fourth graphical elements in response to receiving a selection of a second and/or third graphical element.

### BACKGROUND

1. Field of the Invention

Implementations of various techniques described herein generally relate to performing parametric searches.

2. Description of the Related Art

The following descriptions and examples are not admitted to be prior art by virtue of their inclusion within this section.

A parametric search is a search technique that identifies a desired product by using attributes of that product. The attributes may commonly be referred to as parameters. Typically, parameters are supplied by end users to define the searches. The end user may perform a parametric search to identify a desired product. Each parameter supplied by the end user potentially narrows the number of products that satisfy the search criteria. Generally, end users provide search parameters, examine the search results for those parameters, and provide additional parameters to narrow the search. As a result, parametric searches are iterative searches in which an end user progressively adds more and more parameters to the search until finding the desired product or products.

Because of this iterative process, parametric searches are well suited for computer applications. In fact, parametric search engines are currently being used for searching electronic catalogs on the Internet. An electronic catalog is a series of data records that are logically grouped into various categories. A parametric search engine may be used to search through the hierarchy and structure of data records within electronic databases to find products having specified parameters.

### SUMMARY

Described herein are implementations of various techniques for a method for performing a parametric search on a database. In one implementation, the method includes displaying one or more first graphical elements through a graphical user interface. Each first graphical element represents an application of one or more products. The method may further include displaying one or more second graphical elements in response to receiving a selection of a first graphical element. Each second graphical element represents a product family that may be used in an application that corresponds to the selection of the first graphical element. The method may further include displaying one or more third graphical elements in response to receiving a selection of a second graphical element. Each third graphical element represents a description of a parameter for a product family that corresponds to the selection of the second graphical element. The method may further include displaying a fourth graphical element in response to receiving a selection of one or more third graphical elements. The fourth graphical element represents a description of a product matching one or more parameters that correspond to the selection of the one or more third graphical elements.

Described herein are also implementations of various technologies for a graphical user interface, which may include one or more first graphical elements representing one or more applications of one or more products. Each first graphical element is selectable to display one or more second graphical elements representing one or more product families that may be used in an application corresponding to a selected first graphical element. Each second graphical element is selectable to display one or more third graphical elements representing one or more parameter descriptions for a product family corresponding to a selected second graphical element.

Described herein are also implementations of various technologies for a memory for storing data for access by an application program being executed on a processor. The memory may include a data structure stored in the memory. The data structure may include a table for a product family. The table may include a first column of possible matched products data, a second column of data indicative of possible selection of parameters for the product family, a third column of data indicative of possible products required to use with possible matched products.

Described herein are also implementations of various techniques for a method for performing a parametric search on a database. In one implementation, the method may include identifying a product matching one or more parameters of a family of the product, displaying a first graphical element indicative of the matched product, identifying one or more products required for using the matched product and displaying one or more second graphical elements indicative of the one or more required products.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a schematic diagram of a network environment in which various

FIG. 2 illustrates a schematic diagram of a computing system in which various techniques described herein may be incorporated and practiced.

FIG. 3 illustrates a flow diagram of a method for performing a parametric search in accordance with implementations of various techniques described herein.

FIG. 4 illustrates a graphical user interface in accordance with implementations of various techniques described herein.

FIG. 5 illustrates a display of applicable family products for a selected application in accordance with implementations of various techniques described herein.

FIG. 6 illustrates a display of parameters for a product family in accordance with implementations of various techniques described herein.

FIG. 7 illustrates a display of a product matching a set of parameters for a product family in accordance with implementations of various techniques described herein.

FIG. 8 illustrates a flow diagram of a method for displaying a list of required products description in accordance with implementations of various techniques described herein.

FIG. 9 illustrates a product family table in accordance with implementations of various techniques described herein.

FIG. 10 illustrates a method for displaying a list of additional products description in accordance with implementations of various techniques described herein.

### DETAILED DESCRIPTION

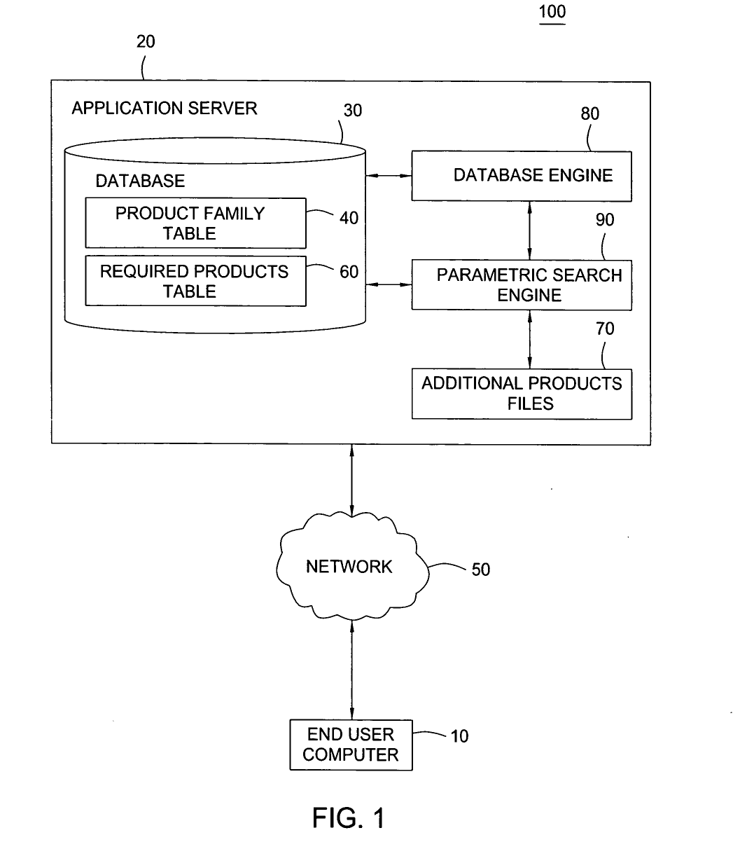

FIG. 1 illustrates a schematic diagram of a network environment 100 in which various techniques described herein may be incorporated and practiced. The network environment 100 may include an end user computer 10 in communication with an application server 20 via a communications network 50. The application server 20 may be any server suitable for allowing end users to perform parametric searches. The application server 20 may run a suitable database engine such as, for example, Microsoft SQL Server, Oracle 8i, or any other suitable database engine. The application server 20 may, for example, maintain product catalogue databases, such as databases for telecommunication related products, integrated circuits, automobile parts, pharmaceutical products, electrical products, construction materials, or any other suitable product or combination of products. In practice, the functionalities of the application server 10 may be integrated into a single server, or may be distributed across multiple servers that are interconnected via the communications network 50. In addition, different product catalogue databases may be maintained on multiple servers that are interconnected via the communications network 50. For example, an end user may maintain a product catalogue locally on personal computer 10. The application server 20 may transmit the appropriate commands to the end user computer 10 in order to perform the parametric search.

The application server 20 may also be a web server suitable for providing on-line access to a parametric search website. The application server 20 may, for example, provide one or more pages to access the end user computer 10 using one or more suitable protocols (e.g., the hypertext transfer protocol (HTTP) and transmission control protocol/internet protocol (TCP/IP)). The pages may be defined using, for example, any suitable markup language (e.g., hypertext markup language (HTML), dynamic hypertext markup language (DHTML), and the like), and may include pages defined using the extensible markup language (XML), JavaServer pages (JSP), active server pages (ASP), or any other suitable approaches. The pages may include scripts, computer code, or subsets of computer code, that define mini-programs (e.g., Perl scripts, Java applets, Enterprise JavaBeans (EJB) or any other suitable approach). The network environment 100 may be designed using suitable approaches, such as Java 2 platform—enterprise edition (J2EE), component object model (COM), distributed component object model (DCOM), or any other suitable approach.

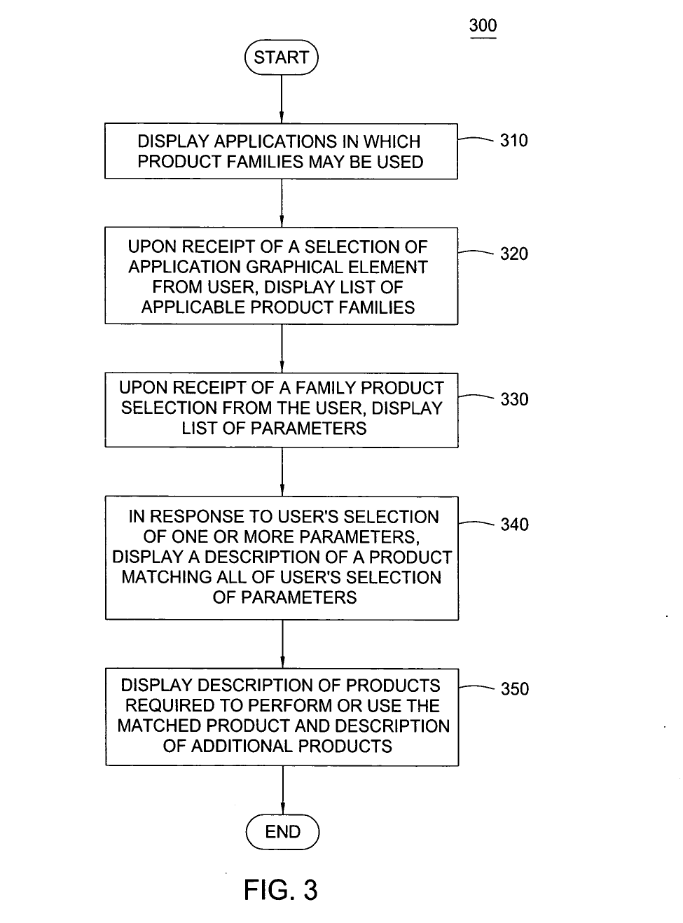

The application server 20 may also include a database 30 for storing data records organized in a manner such that the contents of the data records may easily be accessed, managed, and updated. Examples of database 30 may include IBM's DB2 database, Microsoft's Access database, databases from Oracle, Sybase or Computer Associates, or any other suitable database. The database 30 may include a plurality of tables of data. Each table may include a set of records of data stored in one or more data fields. In one implementation, the database 30 may include a PRODUCT FAMILY table 40 and a REQUIRED PRODUCTS table 60. The application server 20 may further include ADDITIONAL PRODUCTS files 70. The PRODUCT FAMILY table 40, the REQUIRED PRODUCTS table 60 and the ADDITIONAL PRODUCTS files 70 will be described in more detail in the paragraphs below with reference to FIGS. 3 and 8-10. Although only one PRODUCT FAMILY table 40 and one REQUIRED PRODUCTS table 60 are shown, it should be understood that in some implementations the database 30 may include a plurality of PRODUCT FAMILY tables and a plurality of REQUIRED PRODUCTS tables.

The application server 20 may further include a database engine 80, which may be any computer program that allows the end user to create and access data records in the database 30. Examples of database engine 80 may include Microsoft SQL Server, Oracle 8i server, or any other suitable database engine.

The application server 20 may further include a parametric search engine 90, which may be configured to perform implementations of various techniques described herein. The operation of the parametric engine 90 will be described in more detail in the paragraphs below with reference to FIGS. 3 and 8-10. The parametric search engine 90 may be in communication with the database engine 80 and the database 30.

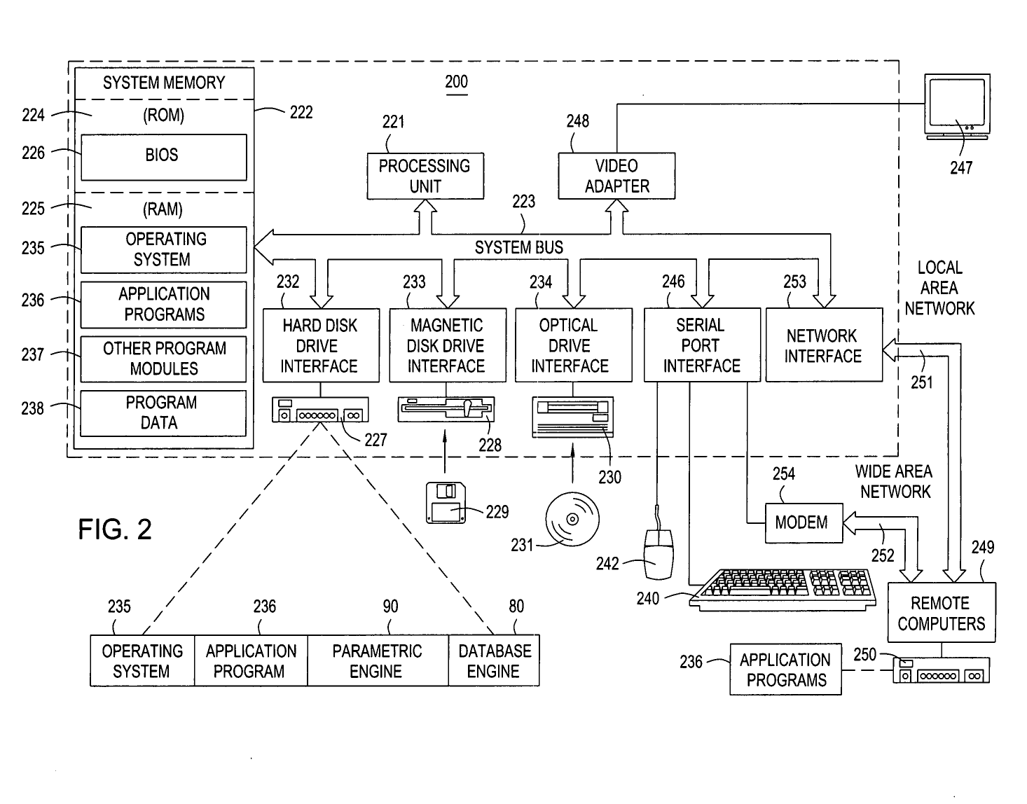

FIG. 2 illustrates a schematic diagram of a computing system 200 that may be representative of the application server 20 or the end user computer 10. The computing system 200 may be a conventional desktop or a server computer. However, those skilled in the art will appreciate that implementations of various techniques described herein may be practiced in various computer system configurations, including hypertext transfer protocol (HTTP) servers, hand-held devices, multiprocessor systems, microprocessor-based or programmable consumer electronics, network PCs, minicomputers, mainframe computers, and the like. Some implementations may be practiced in distributed computing environments where tasks are performed by local and remote processing devices that are linked through a communications network, e.g., by hardwired links, wireless links, or combinations thereof. In a distributed computing environment, program modules may be located in both local and remote memory storage devices.

The computing system 200 may include a central processing unit (CPU) 221, a system memory 222 and a system bus 223 that couples various system components including the system memory 222 to the CPU 221. The system bus 223 may be any of several types of bus structures, including a memory bus or memory controller, a peripheral bus, and a local bus using any of a variety of bus architectures. By way of example, and not limitation, such architectures include industry standard architecture (ISA) bus, micro channel architecture (MCA) bus, enhanced ISA (EISA) bus, video electronics standards association (VESA) local bus, and peripheral component interconnect (PCI) bus also known as mezzanine bus.

The system memory 222 may include a read only memory (ROM) 224 and a random access memory (RAM) 225. A basic input/output system (BIOS) 226, containing the basic routines that help transfer information between elements within the computing system 200, such as during start-up, may be stored in the ROM 224. Although only one CPU is illustrated in FIG. 2, it should be understood that in some implementations the computing system 200 may include more than one CPU.

The computing system 200 may further include a hard disk drive 227 for reading from and writing to a hard disk, a magnetic disk drive 228 for reading from or writing to a removable magnetic disk 229 and an optical disk drive 230 for reading from or writing to a removable optical disk 231, such as a CD ROM or other optical media. The hard disk drive 227, the magnetic disk drive 228, and the optical disk drive 230 may be connected to the system bus 223 by a hard disk drive interface 232, a magnetic disk drive interface 233, and an optical drive interface 234, respectively. The drives and their associated computer-readable media may provide nonvolatile storage of computer-readable instructions, data structures, program modules and other data for the computing system 200. Although the computing system 200 is described herein as having a hard disk, a removable magnetic disk 229 and a removable optical disk 231, it should be appreciated by those skilled in the art that the computing system 200 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 200. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of the any of the above may also be included within the scope of computer readable media.

A number of program modules may be stored on the hard disk, magnetic disk 229, optical disk 231, ROM 224 or RAM 225, including an operating system 235, one or more application programs 236, the parametric search engine 90 and the database engine 80. The operating system 235 may be any suitable operating system that may control the operation of a networked personal or server computer, such as Windows® XP, Mac OS® X, Unix-variants (e.g., Linux® and BSD®), and the like.

An end user may enter commands and information into the computing system 200 through input devices such as a keyboard 240 and pointing device 242. Other input devices may include a microphone, joystick, game pad, satellite dish, scanner, or the like. These and other input devices may be connected to the CPU 221 through a serial port interface 246 coupled to system bus 223, but may be connected by other interfaces, such as a parallel port, game port or a universal serial bus (USB). A monitor 247 or other type of display device may also be connected to system bus 223 via an interface, such as a video adapter 248. In addition to the monitor 247, the computing system 200 may further include other peripheral output devices, such as speakers and printers.

As previously mentioned, the end user computer 10 may be in communication with the application server 20 through the communications network 50, which may include logical connections commonplace in offices, enterprise-wide computer networks, intranets, and the Internet, such as local area network (LAN) 251 and a wide area network (WAN) 252. As such, when using a LAN networking environment, the computing system 200 may be connected to the local network 251 through a network interface or adapter 253. When used in a WAN networking environment, the computing system 200 may include a modem 254 or other means for establishing communication over wide area network 252, such as the Internet. The modem 254, which may be internal or external, may be connected to the system bus 223 via the serial port interface 246. It will be appreciated that the network connections shown are exemplary and other means of establishing a communications link between the computers may be used.

It should be understood that implementations of various techniques described herein may be operational with numerous general purpose or special purpose computing system environments or configurations. Examples of well known computing systems, environments, and/or configurations that may be suitable for use with various techniques described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

It should be further understood that various techniques described herein may be implemented in connection with hardware or software or, where appropriate, with a combination of both. Thus, various techniques, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various techniques.

Generally, program code may include routines, programs, objects, components, data structures, etc., that performs particular tasks or implement particular abstract data types. One or more programs that may implement or utilize the various techniques described herein may use an API, reusable controls, and the like. Such programs may be implemented in a high level procedural or object oriented programming language to communicate with a computer system. However, the program(s) can be implemented in assembly or machine language, if desired. In any case, the language may be a compiled or interpreted language, and combined with hardware implementations.

Implementations of various techniques described herein may also be practiced in distributed computing environments where tasks are performed by remote processing devices that are linked through a communications network. In a distributed computing environment, program modules may be located in both local and remote computer storage media including memory storage devices.

FIG. 3 illustrates a flow diagram of a method 300 for performing a parametric search in accordance with implementations of various techniques described herein. At step 310, one or more applications in which various product families may be used are displayed. A product family may include a number of related products derived from a common product platform having common parts and assemblies. For example, in the area of fiber optic telecommunication networks, a product family may be fiber closures and the products within the fiber closures product family may include 2178-S SMALL FIBER OPTIC SPLICE CASE, 2178-S/FR SMALL FIRE RETARDANT FIBER OPTIC SPLICE CASE, 2178-LS FIBER OPTIC SPLICE CASE, 2178-LS/FR FIRE RETARDANT FIBER OPTIC SPLICE CASE, 2178-LL FIBER OPTIC SPLICE CASE, 2178-LL/FR FIRE RETARDANT FIBER OPTIC SPLICE CASE, SLiC™-3X33F FIBER AERIAL CLOSURE KIT W/RUBBER END SEAL, 2178-S SMALL FIBER OPTIC SPLICE CASE, 2178-S SMALL FIRE RETARDANT, FIBER OPTIC SPLICE CASE, 2178-LS FIBER OPTIC SPLICE CASE, 2178-LS/FR FIRE RETARDANT, FIBER OPTIC SPLICE CASE, 2178-XSB/FR/0G-0T FIRE RETARDANT FIBER OPTIC SPLICE CASE (NO GROUND LUGS/NO TRAY), which may be commercially available from 3M Company of St. Paul, Minn. Although implementations of various techniques are described herein with reference to the fiber closures product family, it should be understood that some implementations may be applied to other product families, such as cabinets, copper closures, copper splicing, copper terminals, diagnostics, fiber connectors, fiber distribution units, fiber splicing, fiber terminals, locators, markers, protected entrance terminals, shrink tubing and the like.

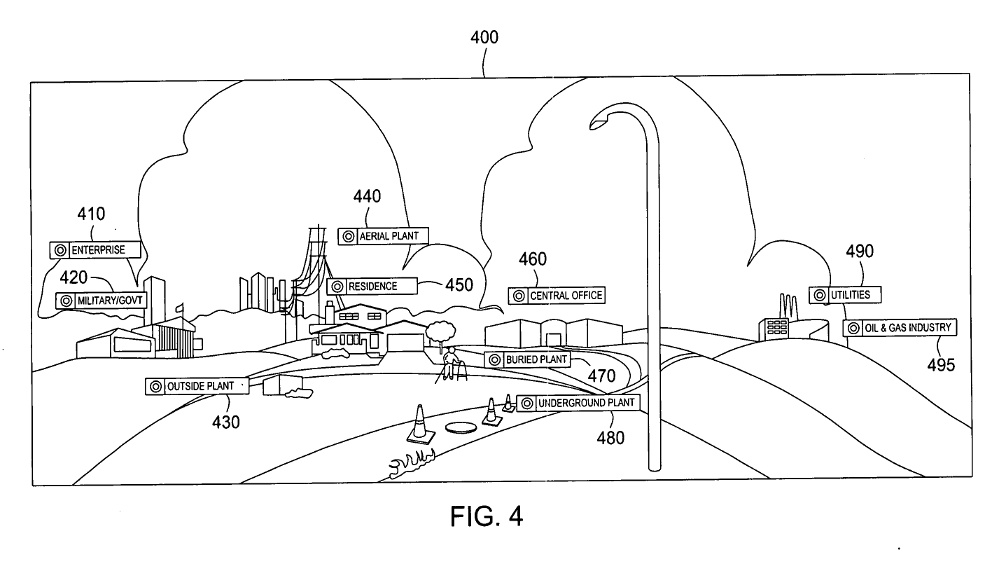

In one implementation, the applications may be displayed as a first set of graphical elements on the graphical user interface (GUI). FIG. 4 illustrates a graphical user interface 400 in accordance with implementations of various techniques described herein. Each application may be displayed as a graphical element on the graphical user interface 400. In one implementation, the graphical user interface 400 may include an ENTERPRISE graphical element 410, a MILITARY AND GOVERNMENT graphical element 420, an OUTSIDE PLANT graphical element 430, an AERIAL PLANT graphical element 440, a RESIDENCE graphical element 450, a CENTRAL OFFICE graphical element 460, a BURIED PLANT graphical element 470, an UNDERGROUND PLANT graphical element 480, a UTILITIES graphical element 490 and an OIL AND GAS INDUSTRY graphical element 495. Each graphical element may be directed to a particular application of certain products. For example, the ENTERPRISE graphical element 410 may be directed to products for connecting and protecting mission-critical cabling infrastructures, including fiber optic, copper and hybrid network distribution and network products. Although various implementations described herein are with reference to various applications in which various product families may be used, it should be understood that in some implementations other features related to the product families may be displayed. Such features may include market segments, business sectors, industries, technical sectors and the like.

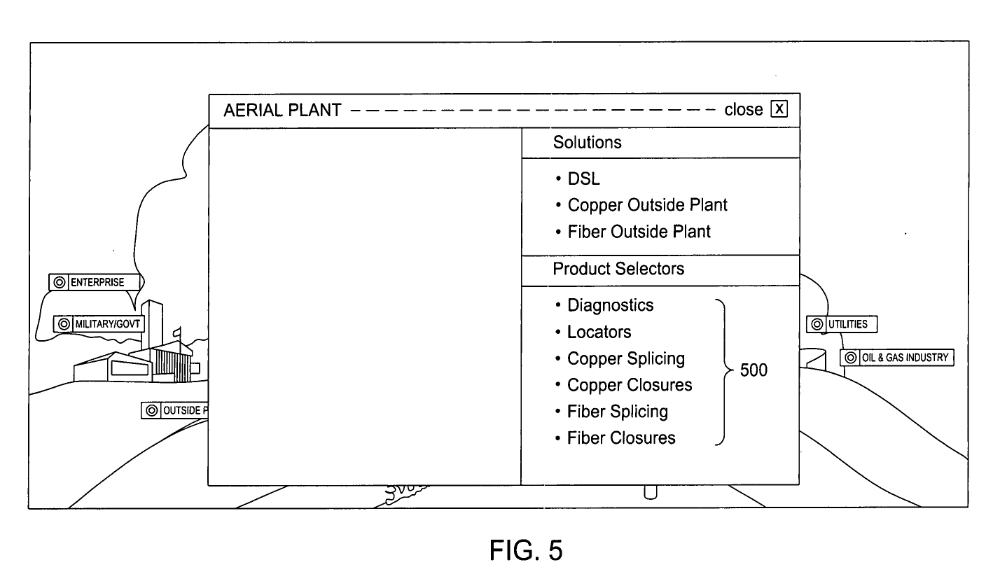

At step 320, upon receipt of a selection of one of the applications by the end user, a list of product families that may be used in the selected application is displayed. In one implementation, the list of product families may be displayed as a second set of graphical elements on the graphical user interface. For instance, FIG. 5 illustrates that DIAGNOSTICS, LOCATORS, COPPER SPLICING, COPPER CLOSURES, FIBER SPLICING AND FIBER CLOSURES product family graphical elements 500 are displayed when the AERIAL PLANT graphical element 440 is selected.

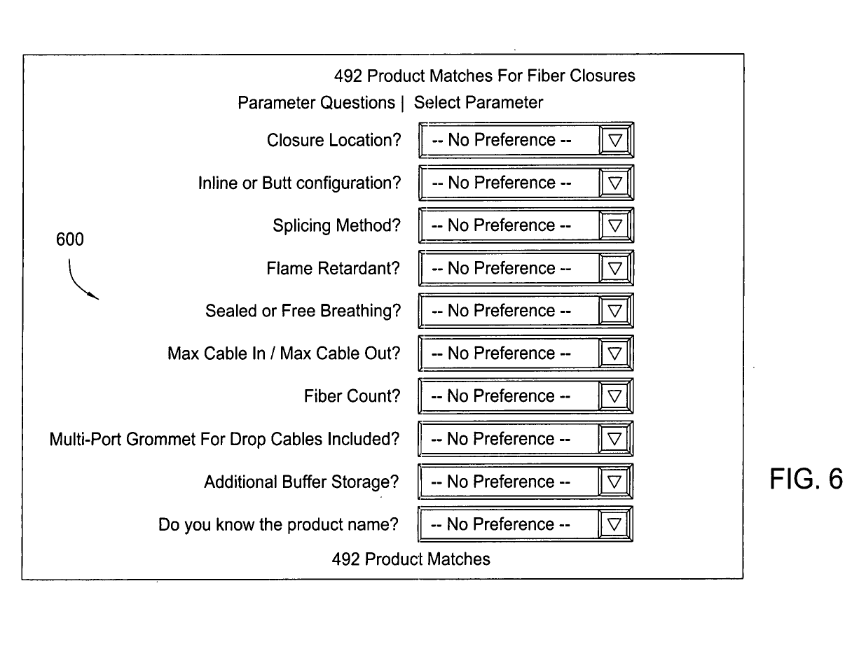

As mentioned above, the operation of the parametric search method 300 may be determined by user-selected parameters. As such, at step 330, upon receipt of a selection of one of the product families from the end user, a list of parameters for the selected product family is displayed. In one implementation, the list of parameters may be displayed as a third set of graphical elements on the graphical user interface. In another implementation, a list of questions pertaining to the parameters may be displayed to the end user. For example, FIG. 6 illustrates CLOSURE LOCATION, INLINE OR BUTT CONFIGURATION?, SPLICING METHOD?, FLAME RETARDANT?, SEALED OR FREE BREATHING?, MAX CABLE IN/MAX CABLE OUT?, FIBER COUNT?, MULTI-PORT GROMMET FOR DROP CABLES INCLUDED?, ADDITIONAL BUFFER STORAGE?, and DO YOU KNOW THE PRODUCT NAME? as the questions 600 pertaining to the parameters when the FIBER CLOSURES product family is selected. In one implementation, the end user may then select a parameter from a drop down menu corresponding to each question.

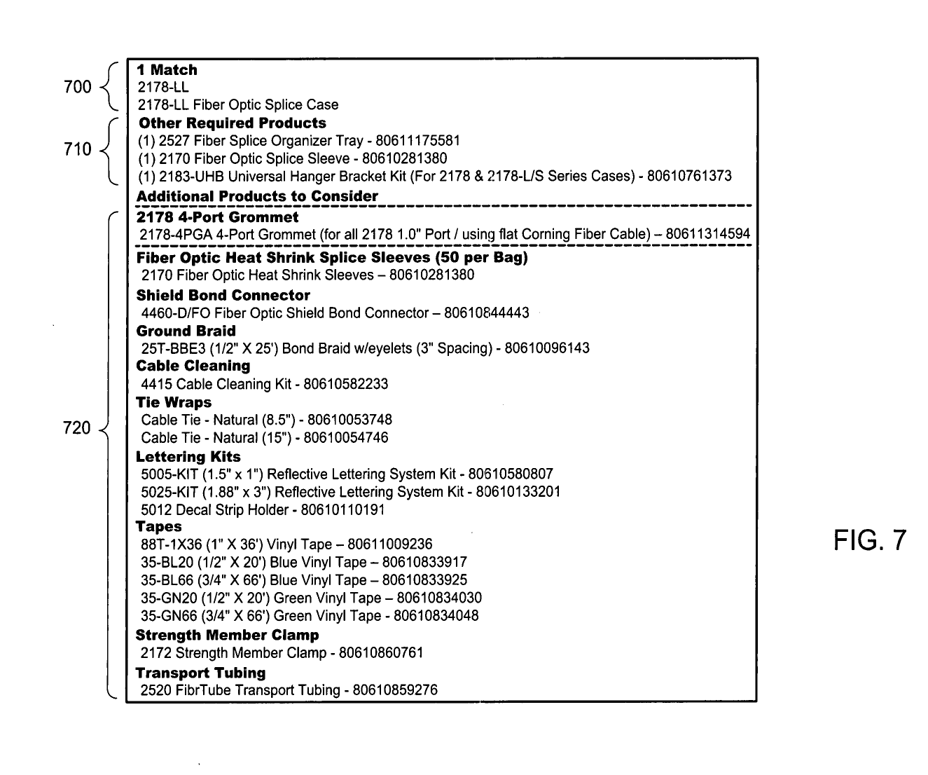

At step 340, in response to the user's selections of the parameters, a product description matching the user's selection of parameters is displayed. In one implementation, the description of the matching product may be displayed as a fourth graphical element on the graphical user interface. For example, FIG. 7 illustrates 2178-LL FIBER OPTIC SPLICE CASE graphical element 700 as the product description that matches a selection of parameters for the FIBER CLOSURES family product. The selection for determining the matched product description may be performed using any parametric search or step search technique. In one implementation, the matched product description may be displayed as a hyperlink, which may be configured to display the matched product in more detail upon selection of the hyperlink. Although only one product matching the user's selection of parameters is displayed, it should be understood that in some implementations more than one product may be displayed as matching the user's selection of parameters.

At step 350, upon determination of the matched product at step 340, a description of one or more products and the quantity required for using or performing the matched product is displayed. In one implementation, the required products description may be displayed as a fifth set of graphical elements on the graphical user interface. For example, FIG. 7 illustrates (1) 2527 FIBER SPLICE ORGANIZER TRAY, (1) 2170 FIBER OPTIC SPLICE SLEEVE and (1) 2183 UHB UNIVERSAL HANGER BRACKET KIT graphical elements 710 as the list of required products required for installing the matched product 2178-LL FIBER OPTIC SPLICE CASE.

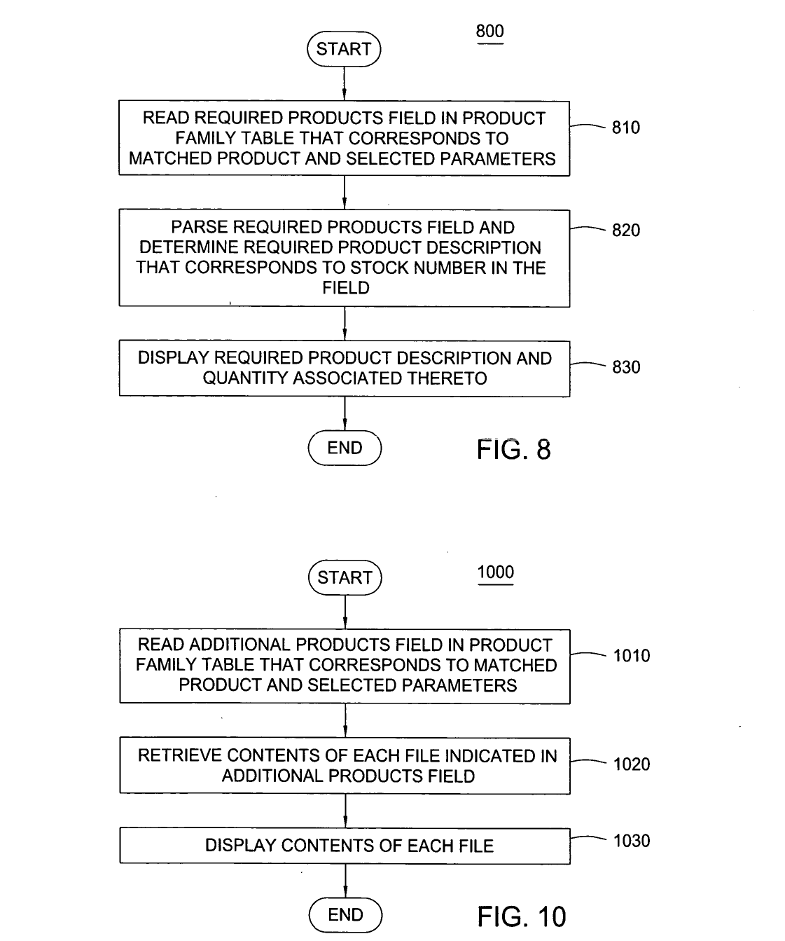

FIG. 8 illustrates a flow diagram of a method 800 for displaying a list of required products description in accordance with implementations of various techniques described herein. In one implementation, once a matched product is determined, a REQUIRED PRODUCTS field in the PRODUCT FAMILY table 40 corresponding to the matched product and the selected parameters is read (step 810). For example, for the matched product 2178-LL FIBER OPTIC SPLICE CASE and the following selection of parameters for the FIBER CLOSURES product family: CLOSURE LOCATION=AERIAL; INLINE OR BUTT CONFIGURATION=INLINE; SPLICING METHOD=FUSION; FIBER COUNT=1-24; ADDITIONAL BUFFER STORAGE=YES; FLAME RETARTANT=NO; SEALED OR FREE BREATHING=SEALED; MAX CABLE IN/MAX CABLE OUT=2 IN/2 OUT; MULTI-PORT GROMMET FOR DROP CABLES=NO AND PRODUCT NAME=2178-LL, the list of required products includes (1) 2527 FIBER SPLICE ORGANIZER TRAY, (1) 2170 FIBER OPTIC SPLICE SLEEVE and (1) 2183 UHB UNIVERSAL HANGER BRACKET KIT.

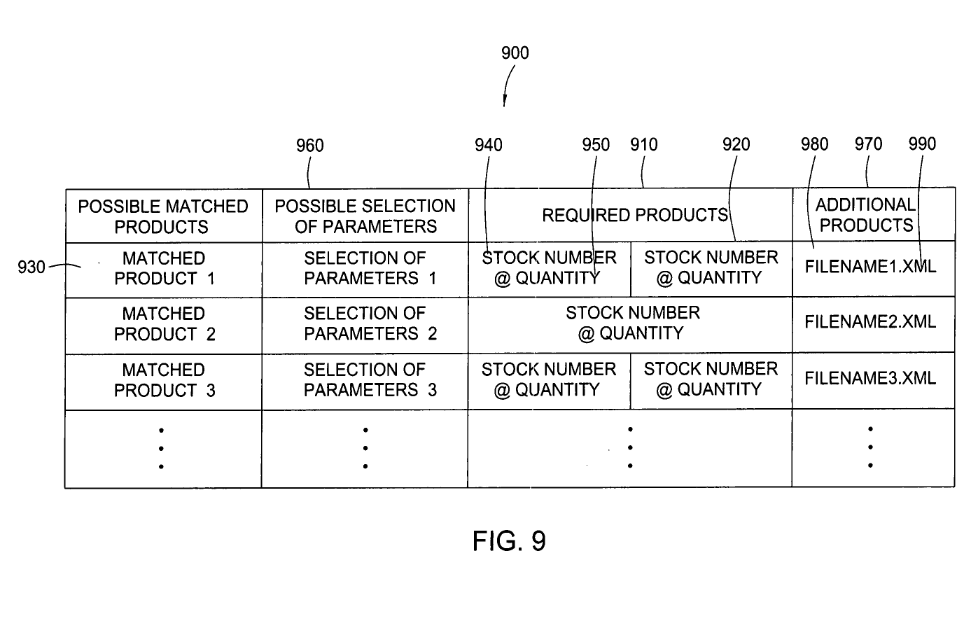

FIG. 9 illustrates a PRODUCT FAMILY table 900 in accordance with implementations of various techniques described herein. In one implementation, the PRODUCT FAMILY table 900 may include a REQUIRED PRODUCTS column 910, which may include a plurality of fields 920, each corresponding to a possible matched product 930 and a possible selection of family product parameters 960. Each field 920 may include one or more stock numbers 940 corresponding to one or more required products and a quantity 950 for each required product. In one implementation, in lieu of stock numbers, the REQUIRED PRODUCTS fields 920 may include the required products description.

Referring back to FIG. 8, at step 820, the REQUIRED PRODUCTS field 920 is parsed and the required product description corresponding to each stock number 940 in the field 920 is determined. In one implementation, the required product description may be determined by performing a look up operation at a required products table, e.g., REQUIRED PRODUCTS TABLE 60. The required products table may include a required product description for each stock number in a given product family. As such, the database 30 may include a required products table for each product family. However, it should be understood that in some implementations the database 30 may include only one required products table for all the product families.

At step 830, the required product description corresponding to each stock number and a quantity associated thereto are displayed. In one implementation, the required product description and the quantity associated thereto are displayed as a hyperlink, which may be configured to display the required product in more detail upon selection of the hyperlink.

Referring back to FIG. 3, at step 350, in addition to the required products description, a list of additional products that may be used in connection with the matched product may be displayed. In one implementation, a description of the additional products may be displayed as a sixth set of graphical elements on the graphical user interface. For example, FIG. 7 illustrates 2178 4-PORT GROMMET, FIBER OPTIC HEAT SHRINK SPLICE SLEEVES, SHIELD BOND CONNECTOR, GROUND BRAID, TIE WRAPS, LETTERING KITS, TAPES, STRENGTH MEMBER CLAMP and TRANSPORT TUBING graphical elements 720 as the list of additional products description for matched product 2178-LL FIBER OPTIC SPLICE CASE.

FIG. 10 illustrates a method 1000 for displaying a list of additional products description in accordance with implementations of various techniques described herein. In one implementation, once the matched product is determined, an additional products field in the product family table that corresponds to the matched product and the selected parameters is read (step 1010).

Referring back to FIG. 9, in one implementation, the PRODUCT FAMILY table 900 may include an ADDITIONAL PRODUCTS column 970, which may include a plurality of fields 980, each corresponding to a possible matched product 930 and a possible selection of family product parameters 960. Each field 980 may include one or more file names 990, each file name corresponding to a file of additional products description, which may be stored in a separate table.

Referring back to FIG. 10, once the ADDITIONAL PRODUCTS field 980 is read, the contents of each file contained in the ADDITIONAL PRODUCTS field 980 are retrieved from the corresponding ADDITIONAL PRODUCTS files 70 (1020). Each file may contain a list of additional products description. In one implementation, the files may be in XML format. At step 1030, the contents, i.e., the list of additional products description, are displayed. In one implementation, the additional products description may be displayed as a hyperlink, which may be configured to display the additional products in more detail upon selection of the hyperlink. Although implementations of various technologies and techniques described herein are with reference to telecommunication related products, it should be understood that some implementations may be applied to integrated circuits, automobile parts, pharmaceutical products, electrical products, construction materials, or any other suitable product or combination of products.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for performing a parametric search on a database, comprising:
displaying one or more first graphical elements through a graphical user interface, wherein each first graphical element represents an application of one or more products;
displaying one or more second graphical elements in response to receiving a selection of a first graphical element, wherein each second graphical element represents a product family that may be used in an application that corresponds to the selection of the first graphical element;
displaying one or more third graphical elements in response to receiving a selection of a second graphical element, wherein each third graphical element represents a description of a parameter for a product family that corresponds to the selection of the second graphical element; and
displaying a fourth graphical element in response to receiving a selection of one or more third graphical elements, wherein the fourth graphical element represents a description of a product matching one or more parameters that correspond to the selection of the one or more third graphical elements.

2. The method of claim 1, further comprising determining the matching product using a parametric search technique.

3. The method of claim 1, further comprising displaying one or more fifth graphical elements in response to receiving the selection of the one or more third graphical elements, wherein each fifth graphical element represents a description of a product required for using or performing the matched product and a quantity for the required product.

4. The method of claim 3, wherein displaying the one or more fifth graphical elements comprises:
reading a field in a required products column of a product family table, wherein the field corresponds to the matched product and the selection of the third graphical elements;
parsing the required products field to obtain one or more stock numbers, each corresponding to a required product and one or more numbers, and one or more numbers, each corresponding to a quantity for the required product; and
determining a required product description for each stock number.

5. The method of claim 4, wherein each fifth graphical element represents the required product description and the quantity for the required product.

6. The method of claim 1, further comprising displaying one or more sixth graphical elements in response to receiving the selection of the one or more third graphical elements, wherein each sixth graphical element represents a description of an additional product that may be used in connection with the matched product.

7. The method of claim 1, wherein the one or more products are telecommunication related products.

8. A graphical user interface, comprising:
one or more first graphical elements representing one or more applications of one or more products, wherein each first graphical element is selectable to display one or more second graphical elements representing one or more product families that may be used in an application corresponding to a selected first graphical element; and
wherein each second graphical element is selectable to display one or more third graphical elements representing one or more parameter descriptions for a product family corresponding to a selected second graphical element.

9. The graphical user interface of claim 8, wherein the third graphical elements are selectable to display a fourth graphical element representing a description of a product that matches parameters corresponding to the selection of the one or more third graphical elements.

10. The graphical user interface of claim 8, wherein the one or more applications comprise at least one of enterprise, military/government, outside plant, aerial plant, residence, central office, buried plant, underground plant, utilities and oil and gas industry.

11. The graphical user interface of claim 8, wherein the one or more products are telecommunication related products and the one or more product families are telecommunication related product families.

12. A memory for storing data for access by an application program being executed on a processor, the memory comprising: a data structure stored in the memory, the data structure comprising a table for a product family, wherein the table comprises a first column of possible matched products data, a second column of data indicative of possible selection of parameters for the product family, a third column of data indicative of possible products required to use with possible matched products.

13. The memory of claim 12, wherein the product family table further comprises a fourth column of data indicative of possible additional products that may be used in connection with the possible matched products.

14. The memory of claim 12, wherein the data indicative of possible additional products comprise a field that corresponds to a possible matched product and a possible selection of parameters for the product family.

15. The memory of claim 12, wherein the data indicative of possible products required to use with possible matched products comprise a field corresponding to a possible matched product and a possible selection of parameters for the product family.

16. The memory of claim 15, wherein the field comprises a stock number corresponding to a required product description and a number indicative of a quantity of the required product.

17. A method for performing a parametric search on a database, comprising:
identifying a product matching one or more parameters of a family of the product;
displaying a first graphical element indicative of the matched product;
identifying one or more products required for using the matched product; and
displaying one or more second graphical elements indicative of the one or more required products.

18. The method of claim 17, wherein identifying the one or more required products comprises retrieving a field of a required product column in a table for the product family, wherein the field corresponds to the matched product and one or more parameters selected to identify the matched product.

19. The method of claim 18, wherein identifying the one or more required products further comprises parsing the field to obtain a stock number and a number.

20. The method of claim 19, wherein the stock number corresponds to a required product and the number corresponds to a quantity for the required product.

21. The method of claim 20, wherein each second graphical element is indicative of the required product and the quantity of the required product.

22. The method of claim 19, wherein identifying the one or more required products further comprises determining a required product description that corresponds to the stock number.

23. The method of claim 17, wherein the product is a telecommunication related product.
